(19) United States
(12) Patent Application Publication
(10) Pub. No.: US 2024/0118800 A1
(43) Pub. Date: Apr. 11, 2024

(54) GRAPHICAL USER INTERFACE FOR WORKLOAD MIGRATION

(71) Applicant: VMWARE, INC., Palo Alto, CA (US)

(72) Inventors: EROL AYGAR, Maynard, MA (US); Megha Bansal, Muzaffarpur (IN); Akhilesh Kumar, Bangalore (IN); Pranay Pareek, Sunnyvale, CA (US); Sairam Veeraswamy, Coimbatore (IN)

(21) Appl. No.: 18/076,428

(22) Filed: Dec. 7, 2022

(30) Foreign Application Priority Data
Oct. 5, 2022 (IN) 202241057106

(51) Int. Cl. G06F 3/0486; G06F 9/50

(52) U.S. Cl. CPC G06F 3/0486; G06F 9/505; G06F 9/5088; G06F 2209/505

(57) ABSTRACT

Systems and methods are described for providing a graphical user interface (“GUI”) for migrating workloads in a system. The GUI can display the locations of edge devices in the system and workloads running on the edge devices. A user can drag a workload from one edge device to another in the GUI, and in response the system can schedule the workload to be migrated accordingly. Before the migration is performed, the GUI can calculate a change in computing resource usage at both edge devices. The GUI can display the usage data and prompt the user to confirm the migration. If the user confirms, the workload can be deployed at the target edge device and removed from the source edge device.

### RELATED APPLICATIONS

Benefit is claimed under 35 U.S.C. 119(a)-(d) to Foreign Application Serial No. 202241057106 filed in India entitled “GRAPHICAL USER INTERFACE FOR WORKLOAD MIGRATION”, on Oct. 5, 2022, by VMware, Inc., which is herein incorporated in its entirety by reference for all purposes.

### BACKGROUND

Computer networks have become increasingly large and complex over time, with some networks spanning continents and even across the world. Many such computer networks are built on cloud-computing systems. These cloud-computing systems can decentralize compute power with edge devices that provide compute resources at an edge location. Workloads, which can be any process or service that utilizes underlying computing resources to accomplish a task or set of tasks, are deployed at edge devices to provide the corresponding service at distinct geographic locations.

One issue with this type of system is that it is cumbersome to migrate workloads or clusters across the edge devices. For example, workloads currently can only be migrated using tools like a Command Line Interface (“CLI”), which requires the knowledge and expertise of an infrastructure administrators. The infrastructure administrator must use multiple applications to migrate a workload. For example, to migrate a workload or cluster from one edge device to another, the infrastructure administrator must view the locations and information about edge devices and workloads in one application, and then set up keys or provide credentials at the CLI. This also requires that the infrastructure administrator sift through a list of available edge devices and manually find a suitable edge device with resources to migrate workloads and clusters to.

As a result, a need exists for a user-friendly interface that allows a user to view edge devices in a system and migrate workloads in a single window.

### SUMMARY

Examples described herein include systems and methods for providing a graphical user interface (“GUI”) for migrating workloads in a system. In an example, an application can send a GUI to a user device, and the GUI can display the locations of edge devices in a system. As an example, edge nodes representing the edge devices can be displayed on a geographic map based on edge devices' geographic locations. The user can interact with an edge node to view additional information about the corresponding edge device and perform certain actions. For example, a user can select an edge node to view the compute stack of the edge node. A compute stack can include a layered abstraction of what services an edge device can provide. This can include hardware capabilities and usage rates, virtual machines (“VMs”) running on the edge device, and workloads deployed at the edge device. A workload can be any service that utilizes underlying computing resources to accomplish a task or set of tasks. In some systems, such as cloud-computing systems, some workloads can be as a service (“aaS”) services, such as Software as a Service (“SaaS”), Data as a Service (“DaaS”), Platform as a Service (“PaaS”), Function as a Service (“FaaS”), and Infrastructure as a Service (“IaaS”).

The GUI can allow a user to migrate a workload. This can include migrating a workload from one edge device to another, copying a workload from one edge device to another, deploying a workload not currently deployed on an edge device, and removing a workload entirely from the system. A user can migrate a workload by performing a predetermined type of input. In one example, a user can select an edge node to view the workloads deployed on the corresponding edge device. The user can select a workload, and in response the GUI can display available actions for the workload, such as migrating, copying, or removing. If the user selects to migrate or copy the workload, then the user can select a target edge node where the workload should be deployed. In another example, the user can use a drag-and-drop type input to simply drag a node representing a workload to a target edge node. For example, dragging a workload node from one edge node to another can cause the system to migrate the workload accordingly. Dragging a workload node outside the geographic map can cause the system to remove the workload from the system. Dragging a workload from outside the geographic map to an edge node can cause the system to deploy the workload at the indicated edge device.

In an example, when the user initiates a drag input of a workload node (or otherwise indicates that the workload should be migrated), the application can identify target edge nodes for edge devices that the workload can be migrated to. For example, the application can compare the computing requirements of the workload to available computing workloads at the edge devices. The GUI can highlight edge nodes that represent edge devices that the workload can be migrated to, such as by changing the formatting of the corresponding edge nodes or by greying out unavailable edge nodes. This allows the user to easily view which edge nodes that the workload can be deployed at. The user can then drag the workload node to an edge node to migrate the workload to the corresponding edge device.

In some examples, the application can calculate the outcome of migrating the workload and display the outcome in the GUI before initiating the migration. For example, the application can display the change in computing resource usage at both the source and target edge devices. The user can review the outcome and determine whether to execute the migration or select another edge device. If the user confirms the migration, the application can instruct a management plane of the system to execute the indicated workload migration.

The examples summarized above can each be incorporated into a non-transitory, computer-readable medium having instructions that, when executed by a processor associated with a computing device, cause the processor to perform the stages described. Additionally, the example methods summarized above can each be implemented in a system including, for example, a memory storage and a computing device having a processor that executes instructions to carry out the stages described.

Both the foregoing general description and the following detailed description are exemplary and explanatory only and are not restrictive of the examples, as claimed.

### BRIEF DESCRIPTION OF THE DRAWINGS

FIG. 1 is a flowchart of an example method for providing a GUI for workload migration.

FIG. 2 is a sequence diagram of an example method for providing a GUI for workload migration.

FIG. 3 is an illustration of an example GUI for workload migration.

FIG. 4 is an illustration of an example system for providing a GUI for workload migration.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

Systems and methods are described for providing a GUI for migrating workloads in a system. The GUI can display the locations of edge devices in the system and workloads running on the edge devices. A user can drag a workload from one edge device to another in the GUI, and in response the system can schedule the workload to be migrated accordingly. Before the migration is performed, the GUI can calculate a change in computing resource usage at both edge devices. The GUI can display the usage data and prompt the user to confirm the migration. If the user confirms, the workload can be deployed at the target edge device and removed from the source edge device. In some examples, the GUI can allow the user to choose between copying and migrating the workload.

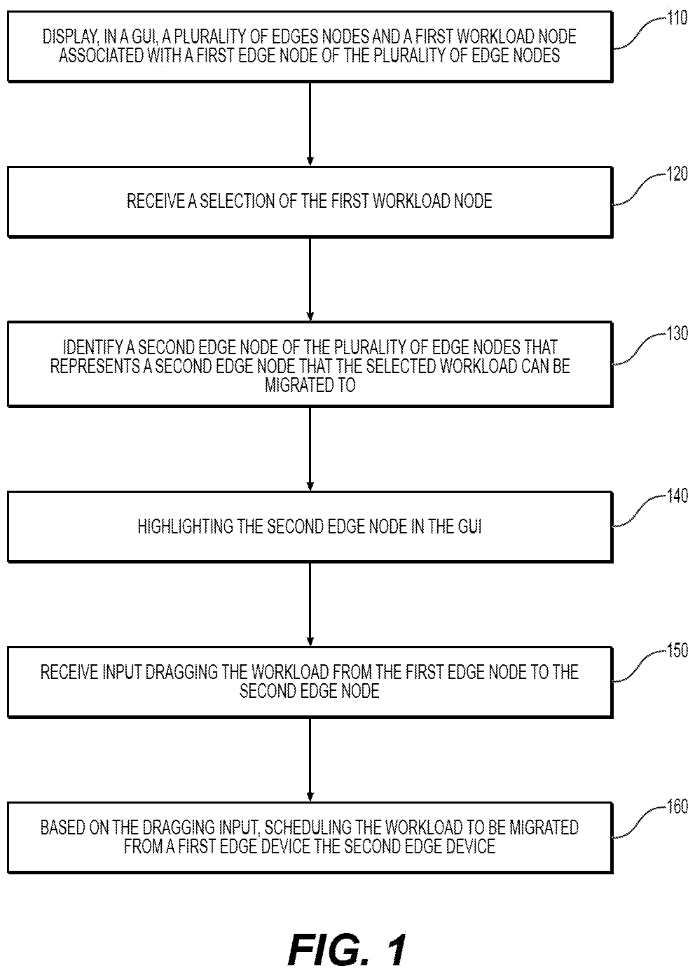

FIG. 1 is a flowchart of an example method for providing a GUI for workload migration. At stage 110, the GUI can display edge nodes and workload nodes. An edge node can represent edge device or a cluster of edge devices in a managed network. An edge device can be a computing device, such as a server or group of servers, that provides compute resources at an edge location. Workload nodes can represent workloads, which can be any process or service that utilizes underlying computing resources to accomplish a task or set of tasks. In some examples, the workloads can be deployed on edge devices in a cloud-based computing environment where the workloads are aaS services. Some examples can include SaaS, DaaS, PaaS, FaaS, IaaS, and so on. In an example, the edge nodes and workload nodes can be displayed on a geographic map. Nodes can be displayed on the map based on the geographic location where they are located.

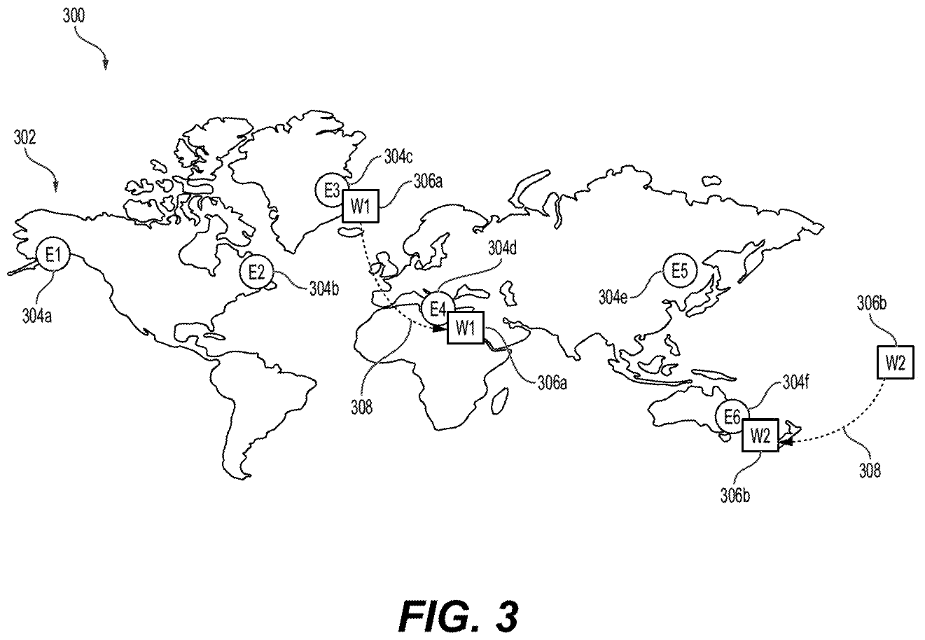

An example of the GUI described herein is illustrated in FIG. 3. The GUI 300 includes a geographic map 302. Although the geographic map 302 is a global map, the geographic map 302 can include only a portion of a global map, such as a single continent or country. In one example, the GUI 300 can allow a user to zoom in and out on the geographic map 302 so that a user can choose which geographic area to view. The GUI 300 displays six edge nodes: edges nodes E1 304a, E2 304b, E3 304c, E4 304d, E5 304e, and E6 304f (collectively referred to herein as “edge nodes 304”). Each edge node 304 represents an edge device in a managed network. The GUI 300 displays two workload nodes: workload nodes W1 306a and W2 306b (collectively referred to herein as “workload nodes 306”). Each workload node 306 represents a workload in the managed network. To help describe the concepts herein, each edge node 304 represents a like-named edge device. For example, edge node E1 304a represents an edge device named edge device E1, edge node E2 304b represents an edge device named edge device E2, and so on. Likewise, each workload node 306 represents a like-named workload. For example, workload node W1 306a represents a workload named workload W1 and workload node W2 306b represents a workload named workload W2. The dashed arrows 308 depicted in the GUI 300 represent a drag input of a user dragging a workload node 306 on the GUI 300. The dashed arrows 308 may not be displayed in the GUI 300.

The GUI can display which workloads are deployed on which edge devices. In one example, workload nodes can be displayed adjacent the edge node of the edge device hosting the workload. In another example, workloads running on an edge device can be displayed in response to a user selecting the corresponding edge node. Using the GUI 300 as an example, before any dragging action by a user, the workload node W1 306a is displayed adjacent the edge node E3 304c, which indicates that the workload W1 is running on the edge device E3. The workload node W1 306a can be displayed adjacent the edge node E3 304c by default or, alternatively, in response to a user selecting the edge node E3 304c. The GUI can allow a user to designate whether workload nodes 306 are automatically displayed or are displayed in response to user input. Workloads not currently running on an edge device can be displayed in a designated location the GUI. For example, in the GUI 300, the workload node W2 306b is displayed outside of the geographic map 302, thereby indicating that the workload W2 is not currently running on any edge device.

The GUI can include filters that allow a user to filter the workload nodes and edge nodes displayed. For example, the user can zoom in or out on the geographic map so that a specific geographic area is displayed. A user can also filter edge nodes by edge device model, by amount of available capacity of a particular computing resource, or by a specific workload deployed on an edge device, as some examples. The filters described herein are merely examples and not meant to be limited in any way, and the GUI can be configured to include any kind of filter for filtering the nodes displayed in the GUI window.

Turning back to FIG. 1, at stage 120, the GUI can receive a selection of a workload node. The selection can be of a predetermined type, such as a tap, a click, a tap and hold, a click and hold, or a hover. The GUI can perform different actions depending on the input type. For example, a tap, click, or hover on a node can cause the GUI to display information about the corresponding edge device or workload, actions that can be performed on the edge device or workload, and so on. For example, for edge devices the GUI can display the edge device's compute stack. A compute stack can include a layered abstraction of what services an edge device can provide. For example, a compute stack can identify which workloads are running on an edge device, identify which virtual machines (“VM”) are running on an edge device, and identify the computing capacity, usage, and availability of the edge device's hardware. Information about a workload can include a name of the workload, computing resources required to host the workload, current or recent measured computing resource usage data, and so on.

At stage 130, the GUI can identify an edge node that corresponds to an edge device that the selected workload can be migrated to. For example, in response to the user selecting a workload node 306, the GUI can compare the computing needs of the corresponding workload to the computing availability of edge devices in the network. In one example, edge devices can continuously or periodically collect and report computing usage data, which can include a breakdown of how much of each computing resource is being used by each workload running on the edge device. This data can be retained at a storage device in the network, such as a database. Usage data can include, as an example, central processing unit (“CPU”) usage rates, memory usage rates, available disk space, network traffic usage, and so on. The management plane can analyze the reported usage data and determine how much of each computing resource is required to host the workload. This determination can be based on average reported usage rates, maximum reported usage rates, or by applying a statistical algorithm to the reported usage data. In some examples, an administrator (“admin”) user can assign usage rates that can be allocated to a workload.

The GUI can identify multiple edge nodes that the workload can be migrated to. For example, after determining the amount of each computing resource needed to host the workload, the GUI can identify all edge devices in the network that have enough available computing resources to host the selected workload.

Although the GUI is described as identifying possible target edge devices, the GUI can be a front-end interface of an application that a user can interact with for managing and migrating workloads. The GUI can display the GUI window, respond to user interactions, and retrieve instructions and data from the application as needed. The application, as an example, can perform certain actions like retrieving computing resource usage data reported by edge devices, determining computing needs of workloads, identifying edges devices that a workload can be migrated to, and communicating with a management plane to execute workload migrations, which is described in greater detail below.

At stage 140, the GUI can highlight edge nodes that the workload can be transferred to. The highlight can be any kind of action or change that emphasizes the available edge devices. For example, edge nodes for available edge devices can be displayed in one color and edge nodes for unavailable edge devices can be displayed in another. In one example, edge nodes for unavailable edge devices can be de-emphasized, such as by greying them out or temporarily removing them from the GUI.

At stage 150, the GUI can receive input dragging the workload to an available edge node. For example, the user can select a workload node and begin dragging the workload node. In response, the GUI can highlight edge nodes for edges that the workload can be deployed to. The user can drag the workload node to one of the highlighted edge nodes and release the selection. In other words, the user can execute a drag and drop of the workload from one edge node to another.

At stage 160, the GUI can schedule the workload to be deployed at the edge device. For example, GUI can notify the application of the drag input from the user and indicate which edge nodes the user dragged the workload node to and from. In response, the application can send instructions to the management plane for migrating the workload. The management plane can then schedule the workload to be deployed at the target edge device (the edge device corresponding to the edge node that the workload node was dragged to). Scheduling a workload to be deployed can include sending all the necessary files and instructions for installing the workload. For example, the management plane can send an installation data file corresponding to the workload and any applicable settings. Alternatively, the management plane can send instructions that include a uniform resource locator (“URL”) or Internet Protocol (“IP”) address of a content delivery server that the target edge device can use to retrieve the necessary data files.

In an example, after the workload is successfully deployed at the target edge device, the management plane can schedule the workload to be removed from the source edge device (the edge device corresponding to the edge node that the workload node was dragged from). For example, the target edge device can notify the management plane when installation of the workload is complete, and in response the management plane can send instructions to the source edge device to remove (i.e., delete or uninstall) the workload.

In some examples, the GUI can allow the user to copy the workload to the selected edge device instead of migrating it. For example, after the user drags the workload to the target edge device, the GUI can prompt the user to indicate whether to migrate or copy the workload. If the user selects to copy the workload, then the management plane can deploy the workload at the target edge device and not instruct the source edge device to remove the workload.

Using the GUI 300 as an example to illustrate the drag input and workload deployment, the workload node W1 306a can begin at the edge node E3 304c, indicating that the workload W1 is deployed at the edge device E3. A user can select the workload node W1 306a, such as with a tap and hold, click and hold, or long press, and drag the workload node W1 306a to another edge node 304 to migrate the workload W1 to another edge node 304. For example, the GUI 300 shows the workload node W1 306a being dragged from the edge node E3 304c to the edge node E4 304d. The dragging motion is illustrated by the dashed arrow 308 between the edge node E3 304c and the edge node E4 304d. This is merely for illustration purposes, and the dashed arrow 308 may not be displayed in the GUI 300. Based on this action, the management plane can deploy the workload W1 at the edge device E4 and remove the workload W1 from the edge device E3.

The GUI can also allow users deploy workloads that are not deployed at any edge device. For example, the workload node W2 306b is shown initially outside of the geographic map 302 in an area that indicates the workload node W2 306b is not currently deployed on any edge device. A user can drag the workload node W2 306b to an edge node 304 to deploy the workload node W2. For example, as shown in FIG. 3, the workload node W2 306b is dragged to the edge node E6 304f. Based on this input, the management plane can deploy the workload W1 at the edge device E4.

A user can also drag a workload node 306 to a designated area to remove the corresponding workload from the network. For example, if the user drags the workload node W2 306b from the edge node E6 304f to outside the geographic map 302 (which would be in the opposite direction indicated by the edge 308), then the management plane can remove the workload W2 from the edge device E6 without redeploying the workload W2.

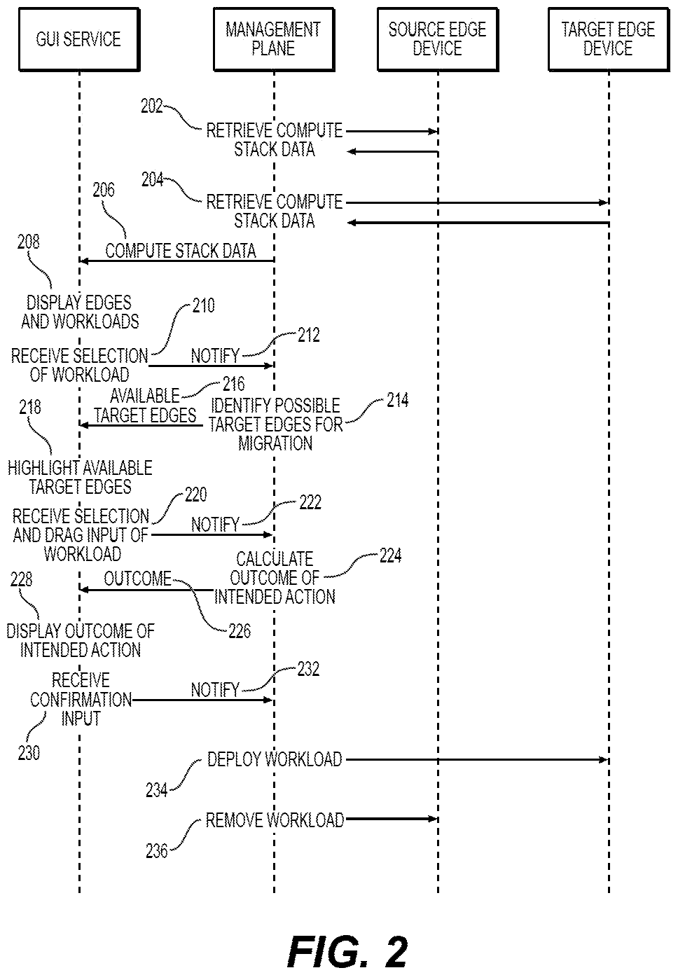

FIG. 2 is a sequence diagram of an example method for providing a GUI for workload migration. At stage 202, a management plane can retrieve compute stack data from a source edge device, and at stage 204 the management plane can retrieve compute stack data from a target edge device. Compute stack data can include a layered abstraction of what services an edge device can provide. Compute stack data can include, for example, hardware capabilities and usage rates, VMs running on the edge device, and workloads deployed at the edge device.

Although the sequence diagram illustrates the management plane retrieving the compute stack data directly from the source and target edge devices, the management plane can retrieve the compute stack data from other sources. For example, some compute stack data can be retrieved from a database or other storage component. As an example, the management plane (or alternatively another service or server in the managed network) can manage a data table that stores information about each edge device. Whenever a workload is added to or removed from an edge device, management plane can update the data table with the change. Additionally, each edge device can measure and report computing resource usage data for each workload that it hosts. This data can be stored on the network at a storage component accessible by the management plane.

In another example, some compute stack data can be pushed to the management plane. For example, a service or agents installed in the managed network can periodically retrieve device state information from each edge device and push the device state information to the management plane. Device state information can include any information about the state of an edge device, such as whether the edge device is reachable, current usage rates of computing resources, and so on.

The management plane can obtain the compute stack data using any appropriate communication protocol. For example, data sent directly to the management plane can be sent using an Application Programming Interface (“API”) call. To retrieve data from a database, the management plane can make a database query to the corresponding database server.

At stage 206, the management plane can send the compute stack data to an application. The application can be a service that generates and manages the GUI for users. The application can be configured with the structure of the GUI and can insert elements and data into the GUI at their appropriate locations. For example, the GUI engine can use location data about an edge device to insert a corresponding edge node at a location in a geographic map of the GUI corresponding to the geographic location.

Sending the compute stack data can include formatting the compute stack data so that it is readable by the GUI engine, and it can also include providing access to the data rather than sending the data. For example, the management plane can create or store a list or data table that indicates what edge devices exist in the system, the names or other identifier (“ID”) of each edge device, the location of each edge device, which workloads are running on each edge device, and so on. Stage 206 can therefore include identifying a storage location associated with the stored list or data table.

At stage 208, the application can use this information to display edge nodes and workload nodes in a GUI window. References to the application displaying items can be performed by a GUI at a user device. For example, the application can compile and format data received from the management plane and send the formatted data to a GUI at the user device. For example, the application can send the formatted data using an API call or an HTTPS call, and the GUI can be displayed at the user's device. The user device can then send any user interactions with the GUI to the application.

The edge nodes and workload nodes can be displayed on a geographic map based on their geographic location. In some examples, the GUI can initially only display the edge nodes. When a user selects an edge node, the application can retrieve additional compute stack data related to the selected edge device and display that data. This can include displaying a workload node for each workload deployed on the corresponding edge device. In some examples, if a large number of edges nodes are concentrated in an area of the geographic map, then the GUI can group such edge nodes into a single node. This can reduce cluttering of edge nodes. A user can select a grouped node or zoom in on a geographic area with a grouped node to view the individual edge nodes.

The user has the option to filter which edge nodes are displayed in the GUI window. For example, the user can zoom in or out on the geographic map so that a specific geographic area is displayed. A user can also filter edge nodes by edge device model, by amount of available capacity of a particular computing resource, or by a specific workload deployed on an edge device, as some examples. The filters described herein are merely examples and not meant to be limited in any way, and the GUI can be configured to include any kind of filter for filtering the nodes displayed in the GUI window.

At stage 210, the application can receive a selection of a workload node. The selection can be of a predetermined type, such as a tap, a click, a tap and hold, a click and hold, or a hover. The GUI can be configured to perform different actions depending on the input type. For example, a tap, click, or hover on an edge node can cause the GUI to display information about the compute stack of the corresponding edge device. A tap, click, or hover over a workload node can cause the GUI to display information about the corresponding workload, such as the type of workload (e.g., SaaS, DaaS, PaaS, FaaS, IaaS, etc.), a name or ID of the workload, usage rates of computing resources, and so on.

In this example, the user can make a type of selection that indicates an intention or desire to migrate a workload. As an example, the user can make one type of selection that causes the GUI to display different actions that can be performed on the workload, such as by tapping a drop-down icon or a right click. The GUI can display the available actions, and the user can select an action for migrating the workload. In another example, the user can initiate a drag-and-drop by selecting or clicking on the workload and not releasing the selection or click.

At stage 212, the application can notify the management plane of the selection. In response, at stage 214, the management plane can identify possible target edges for migration. For example, the management plane can compare the computing needs of the corresponding workload to the computing availability of edge devices in the network. If the user has applied filters, then the management plane can limit the comparison to the edge devices that have not been filtered out. In one example, workloads can report computing usage data, and this data can be retained at a storage device in the network, such as a database. Usage data can include, as an example, CPU usage rates, memory usage rates, available disk space, network traffic usage, and so on. The management plane can analyze the reported usage data and determine how much of each computing resource is required to host the workload. This determination can be based on average reported usage rates, maximum reported usage rates, or by applying a statistical algorithm to the reported usage data. In some examples, an admin user can assign usage rates that can be allocated to a workload.

At stage 216, the management plane can provide the GUI engine with the available target edge devices. As an example, the management plane can create a list with the IDs and/or names of the available target edge devices. In one example, the management plane can send the list using an API call. In another example, the management plane can create a log file that the GUI engine can access.

At stage 218, the application can highlight the available target edges in the GUI. The highlight can be any kind of action or change that emphasizes the available edge devices. For example, edge nodes for available edge devices can be displayed in one color and edge nodes for unavailable edge devices can be displayed in another. In one example, edge nodes for unavailable edge devices can be de-emphasized, such as by greying them out or temporarily removing them from the GUI.

At stage 220, the application can receive a drag input of the workload node from the source edge node to the target edge node. For example, the user can select a workload node at the source edge node and hold the selection. Alternatively, the user can select an action for migrating the workload. In response, the GUI can highlight edge nodes for edge devices that the workload can be deployed to. The user can drag the workload node from the source edge node to the target edge node and release the selection, such as by completing a drag-and-drop action. At stage 222, the application can notify the management plane of the input, such as by identifying the input received at stage 220.

At stage 224, the management plane can calculate an outcome of the intended action. This is an optional step that can allow the user to view how the indicated migration will affect the associated edge devices. For example, the management plane can determine the usage rates of CPU, memory, disk space, and network traffic that the workload uses. The management plane can remove the workload usage rates from the reported usage rates of the source edge device and add the workload usage rates to the reported usage rates of the target edge device. The result will indicate estimated usage rates at the source and target edge devices if the migration occurs.

At stage 226, the management plane can provide the outcome to the GUI engine. At stage 228, the application can display the outcome of the intended action in the GUI window. As an example, the GUI can display graphs for each computing resource at the source and target edge devices. Each graph can display the anticipated usage rates after the migration occurs. In one example, the graphs can display the current and anticipated usage rates, which can allow the user to more easily view how the migration will affect each computing resource.

The user can then be given the option to either confirm or reject the intended migration. For example, if migrating the workload to the target edge device raises a computing resource usage rate above a desired level, then the user can choose not to carry out the migration. The user can drag the workload node to various edge nodes in the GUI to view how such a migration will affect each edge device.

When the user chooses a target edge device, at stage 230, the application can receive a confirmation input from the user. For example, after the user drags a workload node to an edge node, the GUI can display the computing resource data and a message asking the user to confirm or reject the migration. The message can include a selection mechanism, such as a button, that the user can select to confirm the intended migration.

At stage 232, the application can notify the management plane of the confirmation input. At stage 234, the management plane can deploy the workload at the target edge device. This can include the management plane scheduling the deployment. This can include sending all the necessary files and instructions for installing the workload. For example, the management plane can send an installation data file corresponding to the workload and any applicable settings. Alternatively, the management plane can send instructions that include a URL or IP address of a content delivery server that the target edge device can use to retrieve the necessary data files. The management plane can perform any action that initiates the migration of the workload from the source edge device to the target edge device.

At stage 236, the management plane can remove the workload from the source edge device. For example, the management plane can send instructions to the source edge device to remove (i.e., delete or uninstall) the workload. In some examples, the management plane can first wait for confirmation that the workload was successfully deployed at the target edge device. For example, the target edge device can be configured to inform the management plane when the migration is complete. The target edge device can also inform the management plane when a deployment fails. If the deployment fails, the target edge device can be instructed to retry a predetermined number of times, such as two or three. If the number of deployment attempts reaches the threshold, then the GUI can display a message indicating that the deployment failed. The GUI can also display any available information that may inform the user of why the deployment failed, such as an errors reported by the target edge device. The user then has the option to investigate the cause of the failure or deploy the workload to another target edge device.

In an alternative example, some of the stages described above as being performed by the management plane can be performed by the application. For example, the application can request compute stack data from the management plane at stage 406. Also, at stage 214 the application can identify possible target edge devices for migration, and at stage 224 the application can calculate the outcome of the intended migration. The application can perform these stages using the compute stack data received at stage 206. Alternatively, the application can retrieve any needed additional information about the edge devices from the management plane or another component of the system.

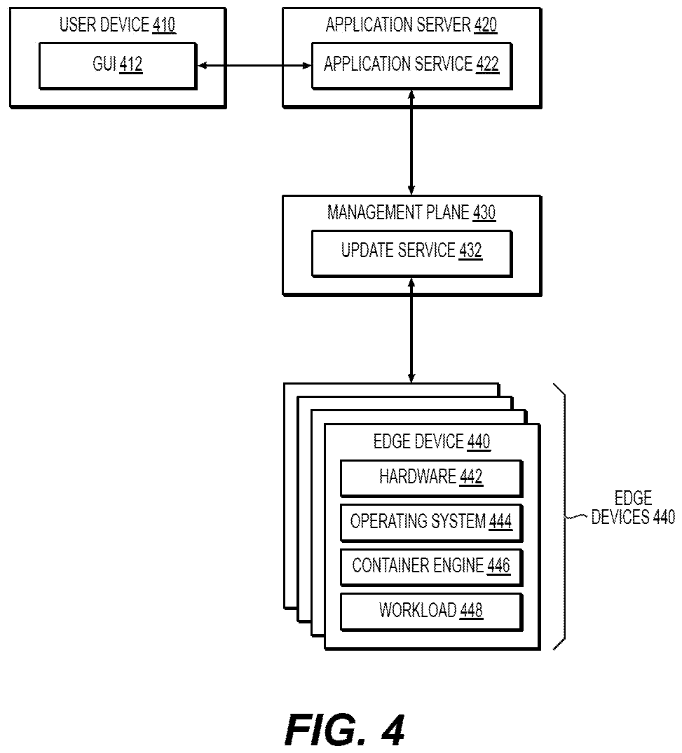

FIG. 4 is an illustration of an example system for providing a GUI 412 for workload migration. The GUI 412 can be provided at a user device 410. The user device 410 can be one or more processor-based devices, such as a personal computer, tablet, or cell phone. The GUI 412 can be a front-end interface of an application 422 that a user can interact with for managing and migrating workloads 448. The application 422 can be hosted by one or more servers 420 or a group of servers, including multiple servers implemented virtually across multiple computing platforms. For example, the application 422 can be hosted by a web server, and a user can access the application 422 through a web browser. Alternatively, the application 422 as a whole, the GUI 412, or other components of the application 422 may be installed directly on the user device 410. Actions described herein as being performed by the GUI 412 can be performed by the corresponding application 422 or service rather than the GUI 412 itself.

The user device 410 and server 420 can communicate using any appropriate protocol. For example, if the GUI 412 is accessed through a web browser, then the user device 410 and the server 420 can communicate using hypertext transfer protocol secure (“HTTPS”) calls, and the server 420 can provide the GUI 412 as part of a hypertext markup language (“HTML”) file. Alternatively, if the application 422 as a whole, the GUI 412, or other components of the application 422 are installed directly on the user device 410, then the user device 410 and server 420 can communicate using API calls.

The application 422 can communicate with a management plane 430 to implement changes in the network made by a user at the GUI 412. The management plane 422 can be an element of a system that configures, monitors, and provides management, monitoring and configuration services to all layers of a network stack and other parts of the system. The management plane 430 can include an update service 432 that is responsible for executing changes to the system made at the GUI 412. The application 422 can communicate with the management plane 430 using any available communication protocol, such as with API calls.

The GUI 412 can allow users to migrate workloads 448 installed on edge devices 440 in a system. An edge device 440 can be a computing device, such as a server or group of servers, that provides compute resources at an edge location. A workload 448 can be any service that utilizes underlying computing resources to accomplish a task or set of tasks. Some examples of workloads 448 can include aaS services, such as SaaS, DaaS, PaaS, FaaS, IaaS, and so on. Each edge device 440 can include hardware 442, one or more operating systems (“OS”) 444, a container engine 446, and workloads 448. The hardware 442 can include any computing hardware, such as a CPU, memory (e.g., random-access memory), disk storage, input/output ports, and so on. The OS 444 can be software that supports the edge device's 440 basic functions, such as scheduling tasks, executing applications, and controlling peripherals. In some examples, the OS 444 can be a hypervisor that manages VMs installed on an edge device 440. The container engine 446 can be an optional component on edge devices 440 that use containerization for deploying applications and workloads. The container engine 446 can manage any containers at the edge device 440.

When a user moves a workload from one edge device 440 to another edge device 440 using the GUI 412, the application 422 can communicate this input to the management plane 430. Based on the input the update service 432 can schedule the workload 448 to be deployed at the target edge device 440. After the workload 448 is successfully deployed, the update service can send instructions to the source edge device 440 to remove the workload 448.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather, any feature of any example described here can be incorporated into any other suitable example. It is intended that the specification and examples be considered as exemplary only, with a true scope and spirit of the disclosure being indicated by the following claims.

What is claimed is:

1. A non-transitory, computer-readable medium containing instructions that, when executed by a hardware-based processor, causes the processor to perform stages for providing a graphical user interface (“GUI”) for workload migration, the stages comprising:
displaying, in the GUI, a plurality of edge nodes and a workload node, wherein the workload node corresponds to a workload and each edge node in the plurality of edge nodes corresponds to an edge device;
receiving a selection of the workload node;
identifying a first edge node of the plurality of edge nodes that corresponds to a first edge device that the selected workload can be migrated to;
highlighting the first edge node in the GUI;
receiving a first input dragging the workload to the first edge node; and
based on the first input, scheduling the workload to be deployed at the first edge device.

2. The non-transitory, computer-readable medium of claim 1, wherein:
the workload is initially displayed adjacent a second edge node, the second edge node corresponding to a second edge device that the workload is deployed on;
the first input includes dragging the workload from the second edge node to the first edge node; and
scheduling the workload to be deployed at the first edge device includes scheduling the workload to be removed from the second edge device.

3. The non-transitory, computer-readable medium of claim 1, wherein identifying the first edge node comprises:
identifying computing resource requirements of the workload;
comparing the computing resource requirements of the workload to available computing resources at the edge devices of the plurality of edge device nodes; and
based on the comparison, determining that the first edge node has the available computing resources for the workload.

4. The non-transitory, computer-readable medium of claim 1, the stages further comprising:
in response to the first input, calculating a predicted compute stack at the first edge device based on the workload being deployed at the first edge device;
displaying, in the GUI, the predicted compute stack; and
receiving second input confirming deployment of the workload to the first edge device, wherein the scheduling the workload to be deployed at the first edge device is based on the second input.

5. The non-transitory, computer-readable medium of claim 1, wherein the edge nodes and the workload node are displayed overlaying a geographic map such that the displayed position of each edge node in relation to the geographic map corresponds to the geographic location of the corresponding edge device.

6. The non-transitory, computer-readable medium of claim 1, wherein the GUI includes a filter tool that allows a user to remove edge nodes based at least one of available computing resources and geographic location.

7. The non-transitory, computer-readable medium of claim 1, wherein, in an instance where the workload cannot be deployed to the first edge device, the GUI prevents the first input from dragging the workload node to the first edge node.

8. A system for providing a graphical user interface (“GUI”) for workload migration, comprising:
a memory storage including a non-transitory, computer-readable medium comprising instructions; and
a hardware-based processor that executes the instructions to carry out stages comprising:
displaying, in the GUI, a plurality of edge nodes and a workload node, wherein the workload node corresponds to a workload and each edge node in the plurality of edge nodes corresponds to an edge device;
receiving a selection of the workload node;
identifying a first edge node of the plurality of edge nodes that corresponds to a first edge device that the selected workload can be migrated to;
highlighting the first edge node in the GUI;
receiving a first input dragging the workload to the first edge node; and
based on the first input, scheduling the workload to be deployed at the first edge device.

9. The system of claim 8, wherein:
the workload is initially displayed adjacent a second edge node, the second edge node corresponding to a second edge device that the workload is deployed on;
the first input includes dragging the workload from the second edge node to the first edge node; and
scheduling the workload to be deployed at the first edge device includes scheduling the workload to be removed from the second edge device.

10. The system of claim 8, wherein identifying the first edge node comprises:
identifying computing resource requirements of the workload;
comparing the computing resource requirements of the workload to available computing resources at the edge devices of the plurality of edge device nodes; and
based on the comparison, determining that the first edge node has the available computing resources for the workload.

11. The system of claim 8, the stages further comprising:
in response to the first input, calculating a predicted compute stack at the first edge device based on the workload being deployed at the first edge device;
displaying, in the GUI, the predicted compute stack; and
receiving second input confirming deployment of the workload to the first edge device, wherein the scheduling the workload to be deployed at the first edge device is based on the second input.

12. The system of claim 8, wherein the edge nodes and the workload node are displayed overlaying a geographic map such that the displayed position of each edge node in relation to the geographic map corresponds to the geographic location of the corresponding edge device.

13. The system of claim 8, wherein the GUI includes a filter tool that allows a user to remove edge nodes based at least one of available computing resources and geographic location.

14. The method of claim 8, wherein, in an instance where the workload cannot be deployed to the first edge device, the GUI prevents the first input from dragging the workload node to the first edge node.

15. A method for providing a graphical user interface (“GUI”) for workload migration, comprising:
displaying, in the GUI, a plurality of edge nodes and a workload node, wherein the workload node corresponds to a workload and each edge node in the plurality of edge nodes corresponds to an edge device;
receiving a selection of the workload node;
identifying a first edge node of the plurality of edge nodes that corresponds to a first edge device that the selected workload can be migrated to;
highlighting the first edge node in the GUI;
receiving a first input dragging the workload to the first edge node; and
based on the first input, scheduling the workload to be deployed at the first edge device.

16. The method of claim 15, wherein:
the workload is initially displayed adjacent a second edge node, the second edge node corresponding to a second edge device that the workload is deployed on;
the first input includes dragging the workload from the second edge node to the first edge node; and
scheduling the workload to be deployed at the first edge device includes scheduling the workload to be removed from the second edge device.

17. The method of claim 15, wherein identifying the first edge node comprises:
identifying computing resource requirements of the workload;
comparing the computing resource requirements of the workload to available computing resources at the edge devices of the plurality of edge device nodes; and
based on the comparison, determining that the first edge node has the available computing resources for the workload.

18. The method of claim 15, further comprising:
in response to the first input, calculating a predicted compute stack at the first edge device based on the workload being deployed at the first edge device;
displaying, in the GUI, the predicted compute stack; and
receiving second input confirming deployment of the workload to the first edge device, wherein the scheduling the workload to be deployed at the first edge device is based on the second input.

19. The method of claim 15, wherein the edge nodes and the workload node are displayed overlaying a geographic map such that the displayed position of each edge node in relation to the geographic map corresponds to the geographic location of the corresponding edge device.

20. The method of claim 15, wherein the GUI includes a filter tool that allows a user to remove edge nodes based at least one of available computing resources and geographic location.
